(19) United States
(12) Patent Application Publication
(10) Pub. No.: US 2024/0269904 A1
(43) Pub. Date: Aug. 15, 2024

(54) Containment Jig of a Holding Apparatus in a Foaming System for Household Appliance Cabinets and Locking Mechanism for said Containment Jig

(71) Applicant: ASTOM S.R.L., Milan (IT)

(72) Inventor: Bruno Moretti, Milan (IT)

(21) Appl. No.: 18/435,268

(22) Filed: Feb. 7, 2024

(30) Foreign Application Priority Data
Feb. 14, 2023 (IT) 102023000002463

(51) Int. Cl. B29C 44/12; B29C 33/20; B29C 44/58; B29L 31/00

(52) U.S. Cl. CPC B29C 44/1204; B29C 33/202; B29C 44/58; B29L 2031/762

(57) ABSTRACT

A containment jig (A) is disclosed of a holding apparatus for household appliance cabinets in a foaming system and its related locking mechanism, which includes holding walls (1, 2, 4), provided with a base edge and a free edge, apt to withhold a pressure force, basements (B1, B2), mutually approachable between a spaced relative position and a close relative position, which the base edges of said holding walls (1, 2, 4) are attached to locking means to constrain said free edges of said holding walls (1, 2, 4) to an opposite one of said basements (B1, B2) when they are in said close relative position, said locking means including, on one hand, one or more locking prongs (5, 6) and, on the other hand, corresponding matching seats, at least one of said locking prongs and said matching seats being mounted adjustable in position by a control.

### CROSS REFERENCE TO RELATED APPLICATION

This application claims the benefit of and takes priority from Italian patent application Ser. No. 102023000002463 filed on Feb. 14, 2023, the contents of which are herein incorporated by reference.

### FIELD OF THE INVENTION

The present invention relates to a containment jig of a holding apparatus in a foaming system for household appliance cabinets, such as refrigerator cabinets. In particular, the invention refers to an adjustable containment jig and its related locking mechanism.

### BACKGROUND ART

As known, some types of household appliance (for example, domestic refrigerators) require to arrange insulating layers between an outer casing, typically made of sheet metal, and an inner operating shell. Typically, refrigerator cabinets comprise a critical insulating layer preventing thermal dispersion between the inside and the outside of the refrigerator. In these instances, the standard manufacturing method involves coupling an inner finishing shell—that is the part visible to the user when he/she opens the refrigerator—with an outer cabinet housing, normally consisting of a parallelepiped-shaped, painted metal sheet, and then foaming an insulating material in a gap between the two.

The material which is injected and foamed in the gap is typically a foamable polyurethane but can also be another foamable insulating material. In the following, the assembly of inner shell coupled with the outer cabinet housing will be referenced to as household appliance body.

Since said gap has a significant volume, precisely because the injected material must act as an effective insulating layer, significant expansion pressures develop during the expansion process of the injected material. To prevent the inner shell and the outer cabinet housing, which are coupled together, from deforming under internal pressures during the expanding phase of the foaming material, it is foreseen that they are temporarily housed in a rigid containment jig of a holding apparatus. It is indeed important that the shell and the outer cabinet housing are held reciprocally coupled and that the respective surfaces are leaning against rigid holding structures, so as not to fail under pressure. Once the crosslinking of the foaming material is completed, the latter gains dimensional stability and does not exert any more pressure, thus the assembly of inner shell, outer cabinet housing and insulation layer can be extracted from the containment jig.

Typically, the holding apparatus is comprised of a frame through which an inner shell and an outer cabinet housing are conveyed. On the frame there is provided the containment jig comprised of holding walls mutually approachable, intended to provide a containment against which the surfaces of the inner shell and outer cabinet housing of the household appliance are leaning. Normally the external holding walls are comprised of a kind of rectangular formwork against which the external sheet metal of the household appliance is leaning, while the internal holding walls are comprised of a male plug element that fits the surface of the inner shell of household appliance: the external walls and internal male plug element in the assembly are arranged mutually approachable to be coupled externally and internally to the household appliance body after it has been introduced into the containment jig.

An exemplary holding apparatus in a foaming system is described in EP3838540.

The internal rigid male plug element is normally firmly attached on a first horizontal basement (arranged at the top or at the bottom in the foaming apparatus), while at least some of the external walls—normally the longest lateral walls—are attached on a second opposite basement, movable with regards to the first. The most commonly used configurations involve mounting the end walls, namely the ones located on the shorter side, on the first basement as well.

Regardless of the specific configuration, in order to best accommodate the household appliance body in the containment jig, the walls are firmly attached with a base edge to only one of the two basements and they come close, with their free edge, to the opposite basement only after a phase of mutual approach of the two basements, which brings the containment jig to a closed condition.

To lock the walls in the closed condition of the containment jig—i.e. when the jig is closed and has to resist the pressure stress of the foaming material—the free edge of the walls is provided with proper means to engage with specific holding pins or blocks provided in the opposite basement. The holding pins or blocks are fixed on the opposite basement, typically securing them to respective matching seats or holes machined in the opposite basement an located on the basis of the specific size of the containment jig to be provided on the holding apparatus.

Sometimes it is necessary to adjust, by a short measure, the mutual distance between the holding walls to be able to accommodate household appliance bodies out of standard gauge (for various reasons, among them imperfections or fitting tolerances), but this involves some problems because the holding pins or blocks are in a fixed position and the containment jig therefor has a compartment of fixed size.

Further, it would be desirable to have a containment jig with sizes adaptable to different household appliance bodies, for example of variable lengths, but the presence of the fixed holding pins or blocks requires modifying the containment jig for each size change to move them to different matching seats.

In the prior art it has already been provided containment jigs having adjustable walls, for example as described in CN102717464 or IT102010901880135. In both these instances, a moving mechanism for the matching seats, with which holding pins are going to couple at the free edges of the holding walls, is provided.

Nevertheless, it has to be noted that the solution proposed in the prior art is not fully satisfactory, because the proposed mechanism is not reliable with respect to the high pressure stress that is exerted on the pins during the expansion phase of the insulating foam. In fact, these solutions involve mounting the matching seats at the end of a control rod which is movable in the same direction to which the pressure stress is exerted on the matching pins. Although the control rod is in the form of a manually operated screw, the control mechanism is subject to failure under operational pressures.

It would be instead desirable to have an adjusting mechanism for the holding pins or, in more general terms, for the locking means, which is more reliable and also automatically controllable.

### SUMMARY OF THE INVENTION

The object of the present invention is, hence, providing a holding apparatus in a foaming system for household appliance cabinets, that solves the abovementioned problem. In particular, it is desirable to provide an adjustment mechanism for the holding pins of the jig's adjustable walls which overcomes the drawback indicated above.

Such object is achieved according to the invention by an apparatus and an adjustment mechanism having the features defined in essential terms in the independent claims attached hereto.

Other preferred features of the invention are defined in the dependent claims.

In particular, according to a first aspect of the invention, it is provided a containment jig for household appliance cabinets of a holding apparatus in a foaming system, comprising
holding walls, provided with a base edge and a free edge, apt to withhold a pressure force,
basements mutually approachable between a spaced relative position and a close relative position, which the base edges of said holding walls are attached to
locking means to constrain said free edges of said holding walls to an opposite one of said basements when they are in said close relative position,
said locking means comprising, on one side, one or more locking prongs and, on the other, corresponding matching seats, at least one of said locking prongs and said matching seats being mounted adjustable in position by a control, wherein
said locking prongs have at least one tooth of a toothed bar, wherein lateral sides of said tooth are arranged substantially orthogonal to a direction of said pressure force,
said matching seat comprises a rack having a pitch equivalent to that of said toothed bar, and
said rack is integral with a slider mounted constrained to move in a longitudinal direction and controlled by a control slider slidably constrained to a substantially perpendicular direction to said longitudinal direction, said slider being coupled with said respective control slider by an inclined plane engagement, and
a movement of said control slider is controlled by a gear motor.

Preferably, said slider integral with the rack is fixed to a key slidably engaging a groove inclined with respect to a longitudinal sliding axis in said control slider.

According to a preferred aspect, the gear motor has a pinion meshed with a control toothed bar arranged longitudinally integral with a side of said control slider.

According to a variant, the gear motor can control a longitudinal displacement of a first connection rod, which in turn is connected to one of a set of control sliders.

Moreover, said sliders of the set of control sliders can be mounted movable along a same axis of longitudinal movement and are connected to each other by respective connection rods.

According to another aspect, it is supplied a locking mechanism of holding walls of a containment jig for household appliance cabinets in a foaming system, comprising
one or more locking prongs apt to be coupled with corresponding matching seats, at least one of said locking prongs and said matching seats being mounted adjustable in position by a control, wherein
said locking prongs have at least one tooth of a toothed bar, wherein lateral sides of said tooth are arranged substantially orthogonal to a direction of a pressure force,
said matching seat comprises a toothed rack having a pitch equivalent to that of said toothed bar, and
said toothed rack is integral with a slider mounted constrained to move in a longitudinal direction parallel to said direction of the pressure force and controlled by a control slider slidably constrained to a substantially perpendicular direction to said direction of the pressure force,
wherein said slider is controlled by said respective control slider by an inclined plane engagement, and
a movement of said control slider is controlled by a gear motor.

### BRIEF DESCRIPTION OF THE DRAWINGS

Additional characteristics and advantages of the invention will anyway result more evident from the following detailed description of a preferred embodiment of the same, given as an example only and being non limiting and illustrated in the attached drawings, in which:

FIG. 1 is a perspective top view of a foaming system with an exemplary containment jig;

FIG. 2 is a perspective view, with some parts removed, of a detail of the locking means according to the invention applied to a transverse wall;

FIGS. 3A and 3B are analogous elevation rear views to FIG. 2, with other parts removed, of the system in FIG. 1;

FIG. 4 is a perspective, partially interrupted, bottom view of the system in FIG. 1;

FIG. 5 is a perspective view analogous to FIG. 4 of a detail of the locking means according to the invention applied to a longitudinal wall;

FIG. 6 is a perspective view of the kinematic control mechanism of a number of locking means corresponding to those in FIG. 5; and

FIG. 7 is an analogous view to FIG. 6 but from a different perspective, of a part of the partially disassembled kinematic mechanism.

### DETAILED DESCRIPTION OF PREFERRED EMBODIMENTS

In a foaming line for household appliance cabinets there is provided a foaming system including a holding apparatus equipped with a containment jig A fitted with a set of containment walls which define a formwork in which the household appliance body is retained during the expanding phase of the foaming insulating material.

In the figures, an exemplary apparatus is shown with a containment jig configured “mouth up”, that is, in which the internal male plug (not showed in the figures) is fixed to an upper basement B1.

Containment walls have a base edge, which is permanently attached to a basement, and a free edge, which is intended to engage the opposite basement when the containment jig is closed. Traditionally, the walls of the containment jig are partially attached to a lower basement B2 and partially to an upper basement B1 and are mutually approachable in a vertical direction, once the household appliance body has been placed inside the containment jig.

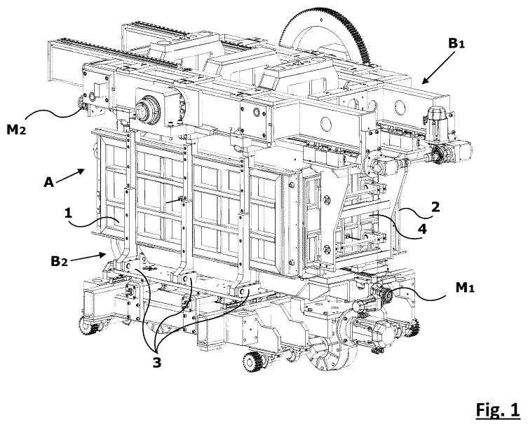

In the embodiment shown in FIG. 1, two longitudinal lateral walls 1 and 2 have their lower base edges attached, by a hinge connecting mechanism 3, at the lower basement B2; vice versa, two transverse lateral walls 4 (in FIG. 1 only one is shown) are mounted with their upper base edge attached to the upper basement B1.

At the end of the vertical run, which brings the upper basement B1 and the lower basement B2 to the minimum mutual distance (condition illustrated in FIG. 1), the free edges of the walls 1, 2 and 4 are engaged and locked to respective locking means of the opposite basements. Then, traditionally, the upper free edge of the longitudinal walls 1 and 2 is provided with one or more locking prongs 5 which engage corresponding matching seats obtained in the upper basement B1. At the same time, the lower free edge of the transversal walls 4 is provided with one or more locking prongs 6 which engage corresponding matching seats obtained in the lower basement B2.

According to a first aspect of the invention, the locking prongs 5 and 6 are provided with at least one tooth 5a and 6a of a toothed bar of predetermined pitch, with the lateral sides of said tooth 5a and 6a arranged substantially orthogonal to the direction of maximum stress to withstand, i.e. perpendicular to the pressure forces that act on the walls 1, 2 and 4 during the expansion of the foaming insulating material (typically from the inside towards the outside of the containment jig A). Further, the matching seat is made of an opposite rack 7a and 8a having a toothed bar of the same predetermined pitch as the pitch of toothed bar of tooth 5a and 6a, constrained to the respective basement B2 or B1 and extending for a certain length, for example for at least about ten teeth.

In this way, the locking prongs 5 and 6 can engage the respective matching seats provided with racks 7a and 8a by coupling between opposite teeth of the respective toothed bar and rack, which allows a mutual locking at different positions, spaced between each other by the pitch of the toothed bar.

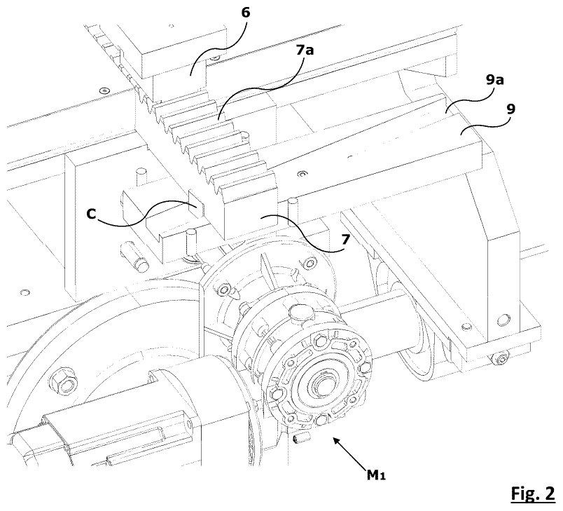

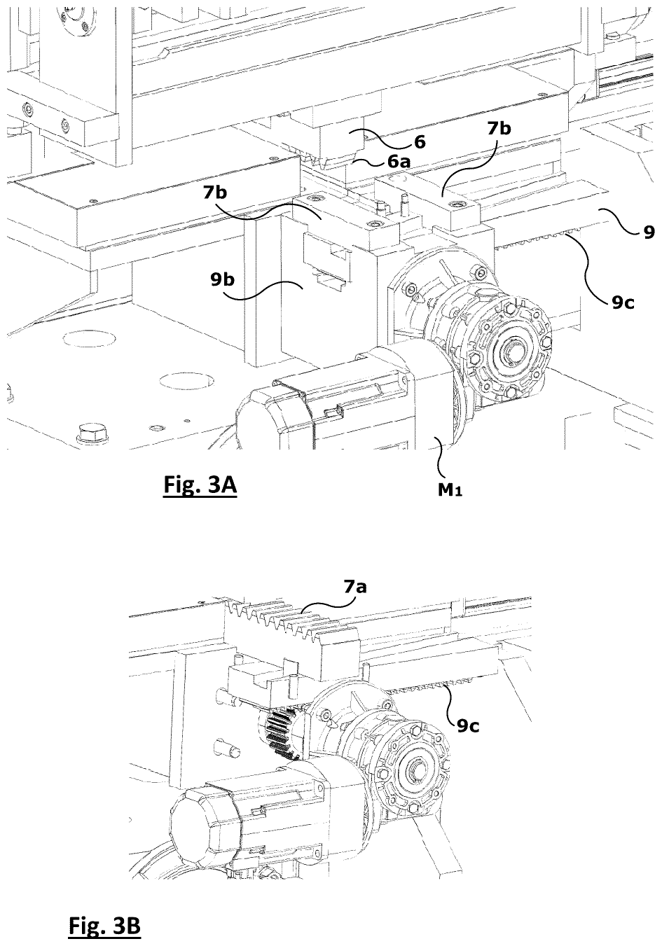

In FIG. 2 a possible coupling position between the teeth of the locking prong 6 and the teeth of the rack 7a in correspondence to the transverse wall 4 is shown in detail. In the illustration of FIG. 3A, in which the rack 7a is removed, the toothed bar (of shorter length with respect to the rack 7a) of the locking prong 6 is instead clearly visible.

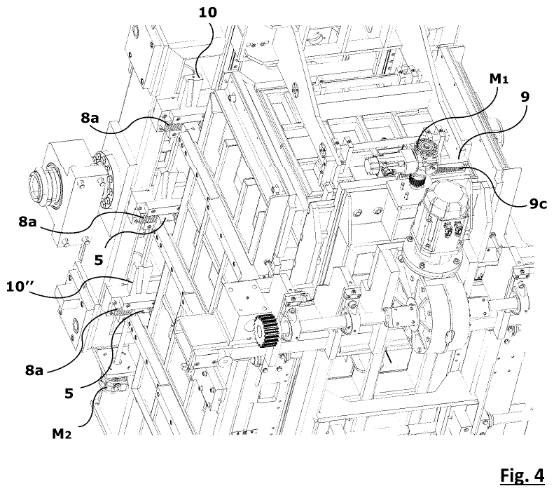

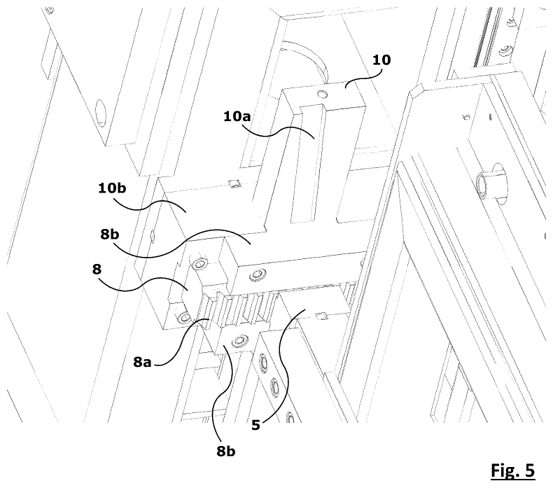

In the FIGS. 4 and 5, the locking prongs 5 and the corresponding racks 8a at the upper edge of the longitudinal side wall 1 are instead clearly visible.

According to a particularly advantageous aspect of invention, additionally, the racks 7a and 8a are obtained on sliders 7 and 8 mounted slidably moveable in the longitudinal direction within respective guiding rails 7b and 8b which prevent a transversal displacement thereof.

The movement of the sliders 7 and 8 of the racks 7a and 8a is controlled by a respective control slider, respectively 9 and 10, which are held within respective control guides 9b and 10b so as to slide only in a substantially perpendicular direction to the longitudinal direction of the racks 7a and 8a. To obtain a displacement of the racks 7a and 8a, the sliders 7 and 8 are coupled with the respective control sliders 9 and 10 by means of a inclined plane engagement, with an inclination of a few degrees, less than 30° and preferably in the order of 15° to ensure irreversibility of the control. For example, as depicted in FIGS. 3 and 5, the sliders 7 and 8 are fixed to a key C which is slidably engaged into grooves 9a and 10a obtained oblique with respect to the longitudinal axis of movement of the control sliders 9 and 10.

In this way, a movement of the control sliders 9 and 10 causes a substantially orthogonal movement of the racks 7a and 8a. Due to the coupling of movements by an inclined plane, a reduction ratio is obtained, whereby one unitary displacement of the control sliders 9 and 10 results in a fraction of the unit displacement of racks 7a and 8a. For the same reason, namely the presence of a reduction ratio between the two movements, the kinematic chain is also of irreversible type: a force applied to the control slider results in a displacement of the racks 7a and 8a, but the opposite is not as easy. This ensures that the position of the racks can be kept stable, without failure of the kinematic transmission chain, even in the presence of high pressure forces transferred to the racks 7a and 8a from the prongs 5 and 6.

With this arrangement, the rack can be displaced by the desired extent and then corresponding teeth can be coupled with any one position taken by the locking prongs 5 and 6, without the tooth pitch limiting the granularity of adjustment.

The displacement of the control sliders 9 and 10 can be obtained in different ways, but it is preferably obtained by dedicated gear motors M1 and M2, properly driven by a configuration logic which controls the entire foaming apparatus.

According to the embodiment depicted in FIGS. 2, 3A and 3B, the gear motor M1 has a pinion P meshed with a control toothed bar 9c arranged longitudinally and integral with a lower side of the slider 9. The operation of the gear motor M1 causes the rotation of the pinion P and thus of the control slider 9 which is integral with the control toothed bar 9c.

The motorized control acts on the individual control slider 9.

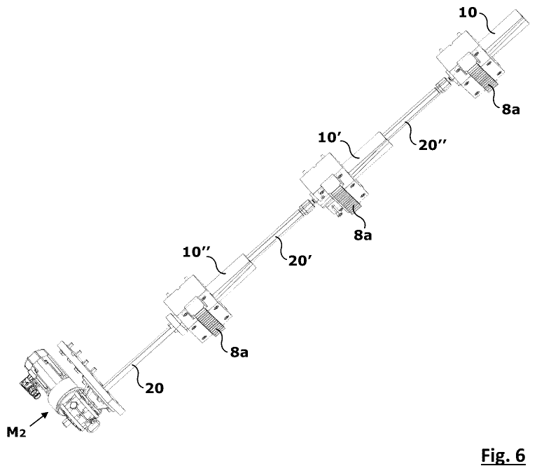

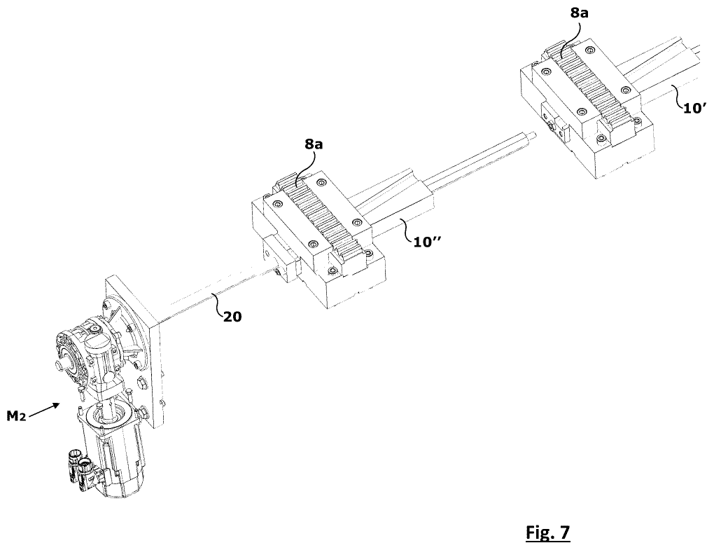

According to the embodiment shown in FIGS. 6 and 7, the gear motor M2 controls the longitudinal displacement of a first connection rod 20, which in turn is connected to one (10″) of the control sliders of an set of control sliders 10, 10′ and 10″ aligned and intended to adjust the position of corresponding aligned racks, for example apt to engage the prongs of a same longitudinal side wall 1.

The sliders 10, 10′ and 10″ of the same set are mounted mountings on the same axis of longitudinal movement and are connected to each other by respective connection rods 20′ and 20″ (preferably adjustable in length).

In this way, the gear motor determines the movement of the first connection rod 20 which, in turn, causes a synchronized displacement of the entire set of sliders via the other connection rods 20′ and 20″. All of the rods 20, 20′ and 20″ and control sliders 10, 10′ and 10″ are designed to move along an axis substantially orthogonal to the axis of movement of the racks along which the pressure forces of the containment walls are exerted.

In this embodiment, the motorized control acts on all of the control sliders 10 simultaneously.

As can be understood from the description provided above, the locking mechanism provided herein allows to perfectly achieve the scope exposed in the premises. In fact, the adjustment mechanism proposed herein allows to readily change the position of the locking means and thus adjust the sizes of the jig without the need to adjust the components of the apparatus every time. The motorization of the control sliders allows to automatically control the position adjustment. The specific arrangement, with the movable control sliders orthogonal to the racks, makes the mechanism reliable also in the presence of significant pressure stress on the containment walls of the jig.

It is intended anyway that the invention should not be considered limited to the particular arrangement illustrated above, which is only an exemplary embodiment of it, but that different variants are possible, all within the reach of a person skilled in the art, without departing from the scope of protection of the invention itself, which is solely defined by the following claims.

What is claimed is:

1. A containment jig (A) for household appliance cabinets of a holding apparatus in a foaming system, comprising
holding walls (1, 2, 4), provided with a base edge and a free edge, apt to withhold a pressure force,
basements (B1, B2), mutually approachable between a spaced relative position and a close relative position, which the base edges of said holding walls (1, 2, 4) are attached to
locking means to constrain said free edges of said holding walls (1, 2, 4) to an opposite one of said basements (B1, B2) when they are in said close relative position,
said locking means comprising, on one hand, one or more locking prongs (5, 6) and, on the other hand, corresponding matching seats, at least one of said locking prongs and said matching seats being mounted adjustable in position by a control, characterized in that
said locking prongs (5, 6) have at least one tooth (5a, 6a) of a toothed bar, wherein sides of said tooth (5a, 6a) are arranged substantially orthogonal to a direction of said pressure force,
said matching seat comprises a rack (7a, 8a) having a pitch equivalent to that of said toothed bar, and in that
said rack (7a, 8a) is integral with a slider (7, 8) mounted constrained to move in a longitudinal direction and controlled by a control slider (9, 10) slidably constrained (9b, 10b) to a substantially perpendicular direction to said longitudinal direction, said slider (7, 8) being coupled with said respective control slider (9, 10) by an inclined plane engagement, and in that
a movement of said control slider (9, 10) is controlled by a gear motor (M1, M2).

2. The containment jig (A) according to claim 1, wherein said slider (7, 8) integral with the rack (7a, 8a) is fixed to a key (C) slidably engaging a groove (9a, 10a) obtained inclined with respect to a longitudinal sliding axis in said control slider (9, 10).

3. The containment jig (A) according to claim 1, wherein said gear motor (M1) has a pinion (P) meshed with a control toothed bar (9c) arranged longitudinally integral with a side of said control slider (9).

4. The containment jig (A) according to claim 1, wherein said gear motor (M2) controls a longitudinal displacement of a first connection rod (20), which in turn is connected to one (10″) of a set of control sliders (10, 10′ and 10″).

5. The containment jig (A) according to claim 4, wherein said sliders of the set of control sliders (10, 10′ and 10″) are mounted movable along a same axis of longitudinal movement and are connected to each other by respective connection rods (20′, 20″).

6. A locking mechanism of holding walls (1, 2, 4) of a containment jig (A) for household appliance cabinets in a foaming system, comprising:
one or more locking prongs (5, 6) apt to be coupled with corresponding matching seats, at least one of said locking prongs and said matching seats being mounted adjustable in position by a control,
characterized in that
said locking prongs (5, 6) have at least one tooth (5a, 6a) of a toothed bar, wherein sides of said tooth (5a, 6a) are arranged substantially orthogonal to a direction of a pressure force,
said matching seat comprises a toothed rack (7a, 8a) having a pitch equivalent to that of said toothed bar, and in that
said toothed rack (7a, 8a) is integral with a slider (7, 8) mounted constrained to move in a longitudinal direction parallel to said direction of the pressure force and controlled by a control slider (9, 10) slidably constrained (9b, 10b) to a substantially perpendicular direction to said direction of the pressure force,
wherein said slider (7, 8) is controlled by said respective control slider (9, 10) by an inclined plane engagement, and in that
a movement of said control slider (9, 10) is controlled by a gear motor (M1, M2).
